(19) United States
(12) Patent Application Publication
(10) Pub. No.: US 2015/0122037 A1
(43) Pub. Date: May 7, 2015

(54) METHOD FOR DIAGNOSING FAULTS IN SLURRY PUMP IMPELLERS

(71) Applicants: SYNCRUDE CANADA LTD. in trust for the owners of the Syncrude Project, Fort McMurray (CA); CITYU PROFESSIONAL SERVICES LTD., Kowloon (HK)

(72) Inventors: KHALED OBAIA, Edmonton (CA); DAN WOLFE, Edmonton (CA); STEFFEN LANGE, Spruce Grove (CA); PETER W. TSE, Kowloon (CN); JACKO T. LEUNG, Kowloon (CN)

(21) Appl. No.: 14/526,757

(22) Filed: Oct. 29, 2014

Related U.S. Application Data
(60) Provisional application No. 61/897,566, filed on Oct. 30, 2013.

(51) Int. Cl. F04D 27/00; G01H 1/00; F04D 7/04

(52) U.S. Cl. CPC F04D 27/001; F04D 7/04; G01H 1/003
USPC 73/660

(57) ABSTRACT

A method of diagnosing the condition of a slurry pump impeller is provided, comprising collecting vibration data from at least one accelerometer mounted to or proximate the pump over a specific time period; calculating indicators from the collected vibration data, the indicators comprising energy level, crest factor, square root amplitude value, and fault growth parameter; and plotting the calculated indicators against time to generate a fault trend indicative of health or deterioration of the impeller. The method further involves predicting the remaining useful life of the impeller using vibration data-driven prognostics.

### FIELD OF THE INVENTION

The present invention relates generally to a method of diagnosing the condition of an impeller of a slurry pump, and predicting the remaining useful life of the impeller.

### BACKGROUND OF THE INVENTION

A conventional centrifugal slurry pump generally includes an impeller having multiple vanes and which is mounted for rotation within a volute casing. The slurry pump imparts energy to the slurry through the centrifugal force produced by rotation of the impeller. The slurry enters into the impeller through an intake conduit positioned in line with the rotating axis and is accelerated by the impeller, flowing radially outward into the volute casing and subsequently exiting through a discharge conduit. A suction sideliner is positioned a predetermined short distance away from the impeller suction side, the distance being so small as to substantially preclude slurry flow between the impeller and the suction sideliner.

Slurries are two-phase mixtures of solid particles and fluids in which the two phases do not chemically react with each other and can be separated by mechanical means. Slurries are typically characterized as either non-settling or settling in accordance with the size of the solid particles suspended within the fluid. Non-settling slurries include fine particles (less than 50 μm) which form stable homogeneous mixtures. Settling slurries include coarse particles (greater than 50 μm) which form an unstable heterogeneous mixture. Examples of slurries include oil/water; tailings/water; and coke/water slurries. Such slurries can cause abrasion, erosion, and corrosion, resulting in significant wear to pump parts.

Attempts have been made to reduce wear of the pump parts, particularly the impeller, volute casing, and suction sideliner. A slurry pump operating at low speeds outlasts a faster running pump. Slower running pumps generally have heavier, larger diameter impellers to spread the energy which causes the wear over a larger area. Various modifications related to the configuration, thickness, number, and arrangement of impeller vanes have been described. For example, thicker impeller vanes are capable of handling an abrasive slurry and minimizing wear, but necessitate a reduction in vane number to avoid narrowing the passageways through which the slurry flows.

Pump parts have been formed of various hard metals, elastomeric, or metal-reinforced elastomeric materials to suit the material being pumped. Rubber-lined pumps are often used for pumping non-settling slurries since the resilience of the rubber can absorb and return the energy generated by the impact of the particles to the slurry; however, rubber-lined pumps can be damaged by sharp, large particles or degraded by hydrocarbons. Metal slurry pumps are suitable for pumping abrasive, settling slurries, with 28% chrome iron being the most common material and stainless steel being used for corrosive slurries. The performance of a chrome impeller may be enhanced by laser cladding which deposits an alloy coating to the surfaces of the impeller.

Among all pump parts, the impeller greatly influences the flow patterns of the slurry and the rate of wear. The average lifespan of an impeller is about 800 to 3,000 hours, which approximates only half the lifespan of the slurry pump itself. During manufacture, an impeller is typically cast as one piece; thus, for replacement, an entirely new impeller needs to be installed.

Maintenance of the pump may be either proactive (i.e., condition-based or scheduled maintenance), or reactive (i.e., run-to-failure maintenance). Frequent inspections require planned scheduled shutdowns. Maintenance hours and downtime of the pump are both time-consuming and expensive. Maintenance is typically based on experience and visual inspection of failed components. Currently, the remaining life of impellers is determined by head ratio which is the difference between the total head the pump is currently producing, divided by the theoretical head that the pump should be producing as per the pump curve. Head ratio has been used to predict pump failure, but provides only limited warning (up to two weeks), and thus restricts the ability to plan maintenance and reduce costs. The variability in service life and operating conditions among different pumps further complicates maintenance planning.

### SUMMARY OF THE INVENTION

The current application is directed to a method of diagnosing the condition of a slurry pump, and predicting the remaining useful life of the pump.

It was initially believed that the remaining life of impellers may be determined by head ratio which predicts pump failure but provides only limited warning, thus restricting the ability to plan maintenance and reduce costs.

However, it was discovered that vibration data collected from pumps during operation can be used to calculate specific indicators which demonstrate consistent polynomial or linear fault trends that reflect the conditions of impellers. In particular, the indicators may include energy level, crest factor, square root amplitude value, and fault growth parameter. Further, the high frequency component in frequency spectra may also be used to reflect the conditions of impellers. It was also discovered that applying specific prediction methods to the collected vibration data may predict the remaining useful life of the impeller. Accordingly, detecting the wear and increasing the lifespan of the impeller can be greatly beneficial in maintaining pump performance and meeting production targets.

Thus, broadly stated, in one aspect of the invention, a method of diagnosing the condition of an impeller of a slurry pump is provided, comprising:
collecting vibration data from at least one accelerometer mounted to or proximate the pump over a specific time period;
calculating one or more indicators from the collected vibration data, the indicators including energy level, crest factor, square root amplitude value, and fault growth parameter; and
plotting the calculated indicators against time to generate a fault trend indicative of health or deterioration of the impeller.

In one embodiment, the method further comprises converting the collected vibration data into frequency signals, and calculating the indicators from the frequency signals.

In one embodiment, the method further comprises applying one or more prediction methods to the collected vibration data to predict the remaining useful life of the pump, wherein the prediction methods are selected from support vector machine (SVM) classifiers, relevance vector machines (RVM) and exponential regression, or a moving-average wear degradation index (MAWDI) and a sequential Monte Carlo (SMC) method.

### DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a diagram showing a time signal divided by several percentages which are used by CF analysis.

FIG. 2 is a graph showing time data of the CF(20%) (degradation) calculated from the G1-C1 accelerometers.

FIG. 3A is a graph showing time data of the CF(20%) calculated from the G1-C1 accelerometers and which was generated by the whole frequency spectrum without degradation.

FIG. 3B is a graph showing the time data of the CF(20%) calculated from the G1-C1 accelerometers and which was generated by the whole frequency spectrum with degradation.

FIG. 4A is a graph showing time data of CF in G1-C1 signal with degradation.

FIG. 4B is a graph showing time data of CF in G1-C1 signal with degradation and y-scale adjustment.

FIG. 5A is a graph showing time data of SRAV in G2-C8 signal with degradation.

FIG. 5B is a graph showing time data of SRAV in G2-C8 signal with degradation and y-scale adjustment.

FIG. 6A is a graph showing a comparison of the Energy (degradation) in G1-C1 time signal.

FIG. 6B is a graph showing a comparison of the Energy (degradation) in G2-C8 time signal.

FIG. 7A is a graph showing a comparison of the SRAV (degradation) in G1-C1 time signal.

FIG. 7B is a graph showing a comparison of the SRAV (degradation) in G2-C8 time signal.

FIGS. 8A-B are frequency spectra of March and May. FIG. 8A is a graph showing the averaged frequency of C1 (G1 pump) in March (top area) and May (bottom area). FIG. 8B is a graph showing the averaged frequency of C8 (G2 pump) in March (top area) and May (bottom area).

FIGS. 9A-B are graphs of the frequency indicators calculated from G1-C1 and G2-C5 that were generated by the high frequency spectra. FIG. 9A shows the Energy (degradation) in C1 high frequency signal. FIG. 9B shows the Energy (degradation) in C5 high frequency signal.

FIG. 10A is a graph comparing predicted RUL (dashed line) to actual RUL (solid line) using the time domain indicators.

FIG. 10B is a graph comparing predicted RUL (dashed line) to actual RUL (solid line), with sub-band energy ranging between 0-400 Hz.

FIG. 11A is a flow chart showing the steps of the RVM method. FIG. 11B shows the sub-steps within the feature extraction step.

FIGS. 12A-B are graphs showing the evolution of energy degradation (FIG. 12A) and its standard deviation (FIG. 12B) as obtained from channel C3 of T2G1 data.

FIG. 13 is a graph showing the estimated RUL of the impeller at inspection time Xj and the corresponding confidence bounds.

FIG. 14 is a graph showing the estimated remaining useful life of the impeller at inspection file number Xj=600 and the corresponding confidence bounds (T2G1-C3).

FIGS. 15A-B are graphs showing the evolution of energy degradation (FIG. 15A) and its standard deviation (FIG. 15B) as obtained from channel C4 of T2G1 data.

FIG. 16 is a graph showing the estimated remaining useful life of the impeller at inspection file number Xj=400 and the corresponding confidence bounds (T2G1-C4).

FIG. 17 is a graph showing the estimated remaining useful life of the impeller at inspection file number Xj=500 and the corresponding confidence bounds (T2G1-C4).

FIG. 18 is a graph comparing the results between the RVM+the sum of exponential regression (bottom curve) and only the sum of exponential regression (top curve). Inspection file number Xj=400. (T2G1-C3).

FIG. 19 is a graph comparing the results between the RVM+the sum of exponential regression (bottom curve) and only the sum of exponential regression (top curve). Inspection file number Xj=500. (T2G1-C3).

FIG. 20 is a graph comparing the results between the RVM+the sum of exponential regression (top curve) and only the sum of exponential regression (bottom curve). Inspection file number Xj=600. (T2G1-C3).

FIG. 21 is a graph showing energy evolution of the frequency band covering the vane-passing frequency.

FIG. 22 is a graph showing a health assessment of an impeller using MAWDI.

FIG. 23 is a flow chart showing the steps for estimating RUL.

FIGS. 24A-C are graphs showing predictive results obtained using the sequential Monte Carlo method at inspection document number 400 for slurry pump impeller (T2G1-C3).

FIGS. 25A-C are graphs showing predictive results using the sequential Monte Carlo method at inspection document number 600 for slurry pump impeller (T2G1-C3).

FIGS. 26A-C are graphs showing predictive results using the sequential Monte Carlo method at inspection document number 700 for slurry pump impeller (T2G1-C3).

FIGS. 27A-C are graphs showing predictive results using the sequential Monte Carlo method at inspection document number 800 for slurry pump impeller (T2G1-C3).

FIG. 28 is a graph showing predicted RUL, its uncertainties, and true RUL (predicted alert document numbers and their confidence limits for slurry pump impeller (T2G1-C3)).

### DESCRIPTION OF THE PREFERRED EMBODIMENT

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

The present invention relates generally to a method of diagnosing the condition of a slurry pump, and predicting the remaining useful life of the pump. Monitoring the condition of a slurry pump plays an important role in ensuring reliability and low-cost operation. One of the most common faults that develop in a slurry pump is a fault in the impeller. The appearance and growth of such faults leave signatures in the vibration signals collected from the pump. Detection and measurement of such signatures in the early stage may be important for effective fault diagnosis and maintenance planning. The evolution of an impeller from a normal to deteriorated condition may be determined by fault trends which are generated from statistical indicators in time and frequency signals.

As used herein, the term “accelerometer” refers to a sensor capable of detecting vibrations emitted by the pump during operation, generating signals representative of the vibrations, and transmitting the signals to a data logger. At least one accelerometer is mounted in, on, or around a slurry pump. In one embodiment, the accelerometer is mounted at various positions on the casing of the pump. In one embodiment, at least four accelerometers are mounted. The accelerometer can be placed close enough to the pump being monitored to perform the fault detection function, such as within any suitable distance sufficient to detect a measurable vibration. In one embodiment, the accelerometer is capable of detecting vibration at a frequency range from about 5 Hz to about 60 kHz.

The accelerometer is operatively connected to a data logger. As used herein, the term “operatively connected” means, in the case of hardware, an electrical connection, for example, wire or cable, for conveying electrical signals, or in the case of firmware or software, a communication link between the processor (which executes the firmware—i.e., operating under stored program control—or software) and another device for transmitting/receiving messages or commands.

The accelerometer generates signals representative of the vibrations emitted by the pump, and transmits the signals to the data logger. The signals generated from the accelerometer are acquired in real time and immediately transmitted to the data logger. It is nevertheless possible for a time offset to remain between the moment the vibration occurred and the moment at which the signals are transmitted to the data logger. In one embodiment, a “one second” vibration signal may be sampled per hour during a 24-hour period. As used herein, the term “data logger” refers to an instrument which allows recordal, collection, storage, and retrieval of the vibration signals over time. In one embodiment, the data logger is a stand-alone data logger including an on-board memory for collecting and storing the acquired vibration signals.

The vibration signals are retrieved from the data logger and transmitted to a host computer remote from the pump. The computer may comprise any desktop computer, laptop computer, a handheld or tablet computer, or a personal digital assistant, and is programmed with appropriate software, firmware, a microcontroller, a microprocessor or a plurality of microprocessors, a digital signal processor or other hardware or combination of hardware and software known to those skilled in the art. The computer may be located within a company, possibly connected to a local area network, and connected to the Internet or to another wide area network, or connected to the Internet or other network through a large application service provider. The application software may comprise a program running on the computer, a web service, a web plug-in, or any software running on a specialized device, to enable the vibration signals to be processed and analyzed.

Statistical indicators are extracted or calculated from the vibration data. The statistical indicators distinguish failure from normal conditions, and avoid the influence of other factors such as, for example, lumps or rocks in the slurry, interference from replacement of casings or other components, or other factors unrelated to pump operation. The statistical indicators process the vibration signals of the pump to yield single values. Such values increase with fault severity so as to reflect the pump's deterioration.

In one embodiment, the statistical indicators comprise energy level (Energy), crest factor (CF), square root amplitude value (SRAV), and fault growth parameter (FGP).

As used herein, the term “Energy” refers to the energy of the vibration signal and is defined as:

$$\frac{\text{?} y ( t )}{T} \\ \text{?} \text{indicates text missing or illegible when filed} \qquad ( 1 )$$

wherein y is the vibration signal, t is time, and T is the total number of sampling points. The Energy of the vibration signal is used to calculate the “CF.” As used herein, the term “CF” refers to a measure of a waveform showing the ratio of peak values to the average value or the extremity of peaks in a waveform, and is defined as:

$$\frac{\sum ( \vert y ( t ) \vert > \vert \text{?} of \text{?} \vert )}{Energy} \\ \text{?} \text{indicates text missing or illegible when filed} \qquad ( 2 )$$

wherein y is the vibration signal, and t is time. Since CF is calculated from dividing the maximum peak value of the vibration signal by its Energy, the calculated result might be affected by the maximum peak which may not be generated by pump operation. In order to minimize the domination of the peak, the absolute values of more peaks are added together instead of just one peak as long as these peaks exceed the certain percentages of the maximum peak-to-peak value. In one embodiment, CF(20%) is used to add the peaks that exceed 20% of a signal's maximum peak-to-peak value together because this percentage provides similar results of other percentages and can serve as an accurate indicator to represent the degree of deterioration of the pumps. Different from conventional CF that only counts on the maximum peak value, CF(20%) uses the absolute values of the peaks that exceed the defined percentage, thereby minimizing the domination of factors unrelated to pump operation and providing greater accuracy.

As used herein, the term “square root amplitude value” (abbreviated as “SRAV”) is defined as:

$${( \frac{1}{T} \text{?} \sqrt{\vert y ( t ) \vert} )}^{2} \\ \text{?} \text{indicates text missing or illegible when filed} \qquad ( 3 )$$

wherein y is the vibration signal, t is time, and T is the total number of sampling points.

As used herein, the term “FGP” refers to the part (percentage of points) of the residual error signal, which exceeds three standard deviations calculated from the baseline residual error signal taken when the run began. The FGP is defined as:

$$100 \text{?} \frac{( y ( t ) > \text{?} + \text{?} )}{T} \\ \text{?} \text{indicates text missing or illegible when filed} \qquad ( 4 )$$

wherein y is the vibration signal, t is time, T is the total number of sampling points, and is σ₀ the baseline standard deviation.

Whole frequency spectra are used for extracting the indicators from time signals, and high frequency spectra are used for extracting the indicators from frequency signals since most of the energy changes due to different conditions of impellers are concentrated within this region. The trends obtained from both time and frequency indicators generally show similar results, with upward trends being observed for most indicators.

The statistical indicators in time and frequency signals are used to generate fault trends which reflect the health or deterioration of the impeller. The fault trend may be either a polynomial (2^{nd} or higher order) trend or a linear trend. As used herein, the term “polynomial trend” refers to a curved line which is used when data fluctuate. As used herein, the term “linear trend” refers to a best-fit straight line which is used with linear data sets. Preferably, the polynomial trend is used to construct trends for all indicators, while the linear trend is used when the polynomial trend fails to demonstrate any trend movements.

The fault trends may be better observed by further processing using “degradation” and “y-scale adjustment” operations. The “degradation” operation reveals any slight upward and downward movements of fault trends calculated from the indicators. By subtracting the indicator's mean value from each data point and plotting the residual value, the effect of data points' fluctuations created by worn impellers can be enhanced and the motions of trends dominated by the fluctuations are more clearly observed.

Following the degradation operation, the y-scales of the degraded indicators are adjusted based on the distribution of the data points. In one embodiment, 2% of the data points from the top of the plot are treated as abrupt points or outliers which were likely generated by factors unrelated to pump operation and are eliminated by adjusting the y-scale. The remaining 98% of data points from the bottom are preserved in the adjusted y-scale plot. The adjusted y-scale plot provides a better view of the deterioration trend.

The fault trends of the indicators serve to diagnose the health or deterioration of the impeller. In one embodiment, the computer is programmed to emit an alert to the operator upon determination that the vibration data are indicative of deterioration of the impeller. The operator may be alerted for example, through a message on the computer or via internet, email, text message, and the like.

The present invention thus conveniently enables an operator to obtain data remotely from the pump regarding the condition of the impeller without having to inspect the pump in person. The vibration data may be collected easily and rapidly from multiple data loggers, eliminating the time, effort and expense incurred by personnel having to inspect multiple pumps in person. Errors in recording data can also be minimized since all data may be compiled and processed using a single computer. The vibration data may be used to detect the early stages of deterioration, allowing the impeller to be repaired or replaced before an expensive failure occurs.

However, while the fault trends of the indicators serve to diagnose the health or deterioration of the impeller, they do not predict the remaining useful life (“RUL”) of the pump impeller. As used herein, the term “RUL” refers to the time period before complete pump failure. The present invention provides RUL estimation methods which are vibration-data driven prognostics as follows:

a) Binary Support Vector Machine (SVM) classifiers;

### b) Relevance Vector Machines (RVM) and Exponential Regression; and

c) A Moving-Average Wear Degradation Index (MAWDI) and Sequential Monte Carlo (SMC) method.

As used herein, the term “SVM” refers to a supervised learning model with associated learning algorithms which analyze data and recognize patterns, used for classification and regression analysis. The SVM takes a set of input data and predicts, for each given input, which of two possible classes forms the output. Given a set of training examples, each marked as belonging to one of two categories, a SVM training algorithm builds a model that assigns new examples into one category or the other. A SVM model is a representation of the examples as points in space, mapped so that the examples of the separate categories are divided by a clear gap that is as wide as possible. New examples are then mapped into that same space and predicted to belong to a category based on which side of the gap they fall on. The SVM is used to recognize the severity of a fault in the impeller.

As used herein, the term “RVM” refers to a machine learning technique which uses Bayesian inference to obtain solutions for regression and classification. The RVM has an identical function form to that of SVM, but provides probabilistic classification. The Bayesian formulation avoids the set of free parameters of the SVM. The RVM is used to predict the fault trends.

As used herein, the term “SMC” or particle filters refers to a model estimation technique for estimating Bayesian models in which the parameters are connected in a Markov chain. “Filtering” refers to determining the distribution of parameters at a specific time, given all observations up to that time. Particle filters allow for approximate “filtering” using a set of “particles” (differently weighted samples of the distribution). This method involves performance degradation assessment which is the basis of the RUL estimation.

The above estimation methods have been developed to process and analyze the collected vibration data to predict the RUL. If RUL is known within a certain confidence and acceptable tolerance, early planning can be made to have a replacement in time, which may lead to cost savings, an appropriate selection for installation time, and avoidance of sudden pump breakdown.

### Example 1

Field vibration data were used to diagnose the conditions of slurry pumps. The data were collected from thirty-two accelerometers capable of detecting vibrations having frequencies between 5 Hz to 60 kHz (PCB Piezotronics; part #352A60), and installed on the casings of eight slurry pumps (designated as Train 2(237-2G): G1, G2, G4 and G5; and Train 3(237-3G): G1, G2, G4, and G21). Each pump was instrumented with four accelerometers connected to stand-alone data loggers, of which six were deployed in the field at the different pump houses. Logging sessions were scheduled once per hour (later at every 30 minutes) to log signals for 1 second at 50 kHz sampling frequency. Later, sampling frequency was increased to 60 kHz to use the full frequency range of the accelerometers.

Vibration data files were recorded in time domain waveform onto the hard drives of the data loggers. The data files were then retrieved from the data loggers for post-processing and evaluation of indicators for pump impeller deterioration. LabVIEW™ (National Instruments) was used to develop the necessary virtual instruments for vibration features extraction and analysis. Instantaneous monitoring and advanced fault diagnosis were performed by using the virtual instruments. Several diagnostic techniques, such as signal pre-processing, higher order statistical analysis, sub-band analysis and fault trend generation, were adopted in the measurement interface for determining the health status of the impeller.

Vibration data were collected from Train 2 pumps G1 and G2. Eight accelerometers (C1 to C8) were installed on the pump casing. Accelerometers C1, C4, C5 and C8 were located near the discharge of the pumps, while other accelerometers were attached in different locations around the casing circumference. A “one second” data file was sampled once per hour daily. Several data files were used for determining the baseline of the impellers' normal condition and their deterioration before replacement.

The selected higher order statistical indicators of vibration data included Energy Level (Energy), Crest Factor (CF), Square Root Amplitude Value (SRAV), and Fault Growth Parameter (FGP).

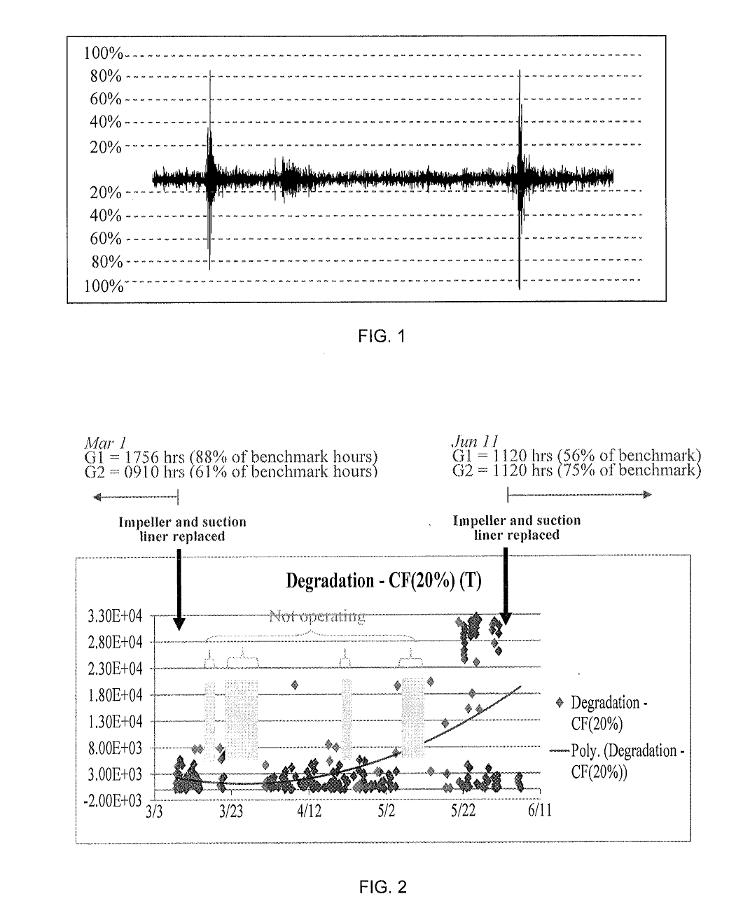

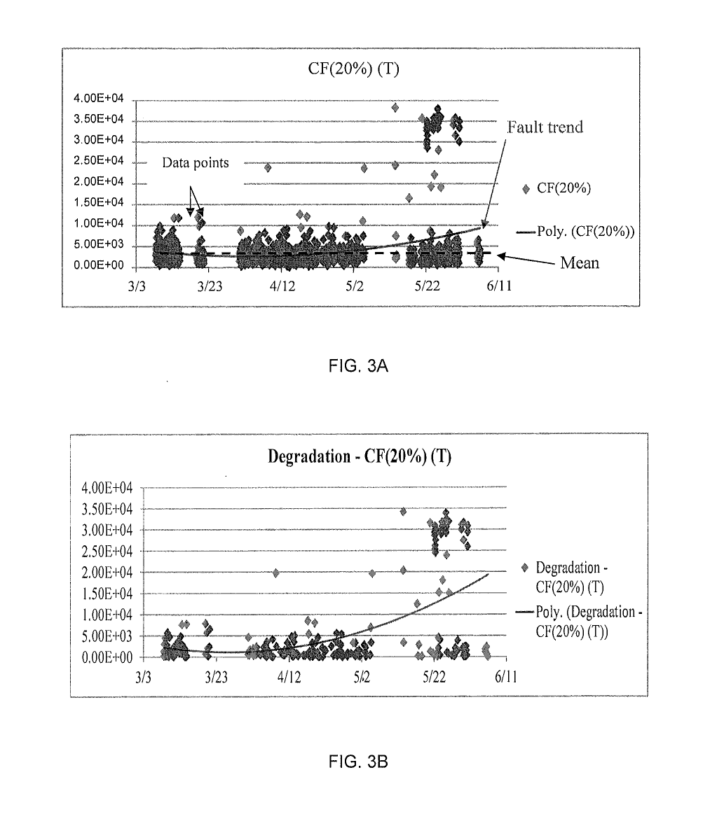

For CF, the signal was divided into several percentages (20%, 40%, 60%, 80%, and 100%) of the maximum peak, which were used for calculating CF(20%), CF(40%), CF(60%), CF(80%), CF(100%), respectively. When the peaks exceeded the corresponding percentage (e.g. 20%), the absolute values of the exceeded peak values were added together and the sum was divided by the energy of the signal (FIG. 1). CF(20%) was calculated from the time domain signals of C1 between March 8 to June 5, and with the degradation operation applied. The mean value of all the data points which have been subtracted by the data points themselves and only those residual values were plotted (FIG. 2), This operation better reveals the direction of the trend (curved line) when compared with the original trends even when there is only a slightly upward or downward motion. A whole operating cycle from normal condition to the next replacement is shown. The results show the health conditions of the impellers without interferences from casings which were replaced with the impellers simultaneously. Almost 30% of the monitored period has no data (the boxed time intervals). However, an upward trend which was calculated from the data points can still be observed and reflects the deterioration of the impeller. In the maintenance history of G1 and G2 (data not shown), both pumps were replaced below the benchmark hours. Both G1 and G2 pumps operated to 1120 hours and reached 56% and 75% of benchmark hours, respectively.

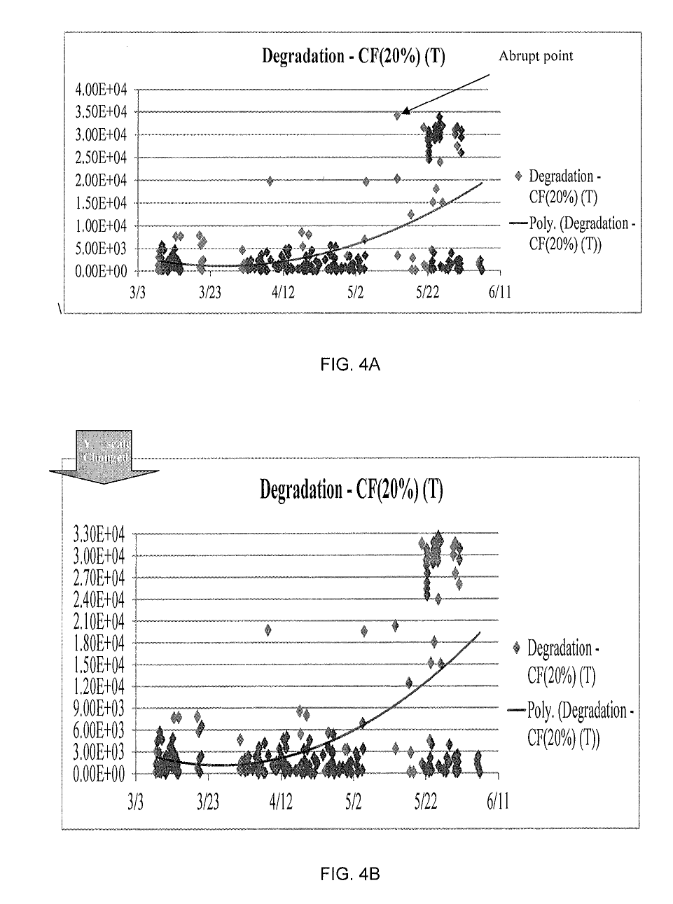

The indicators were used to reflect the health conditions of impellers by generating fault trends. The data points concentrate within a lower position when the impellers were running at a relatively good condition (FIG. 3A). However, when the running hours of the impellers approached the benchmark hours, a portion of the data points exhibits a large fluctuation. Since the trends are generated from the values of data points, their upward and downward motions can be affected by the large portion of data points. Even when a part of the data points carried fluctuation due to the worse running conditions of impellers, the majority of data points are still close to mean value. Therefore, the motions of trends can be restricted by the data points close to the mean value and the effect of the fluctuation can be minimized.

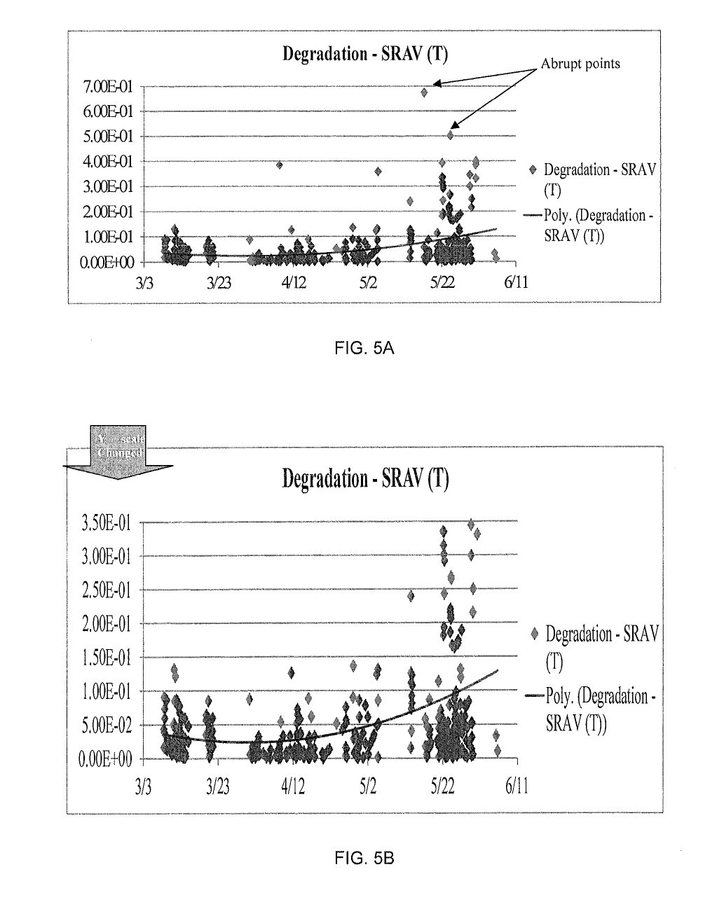

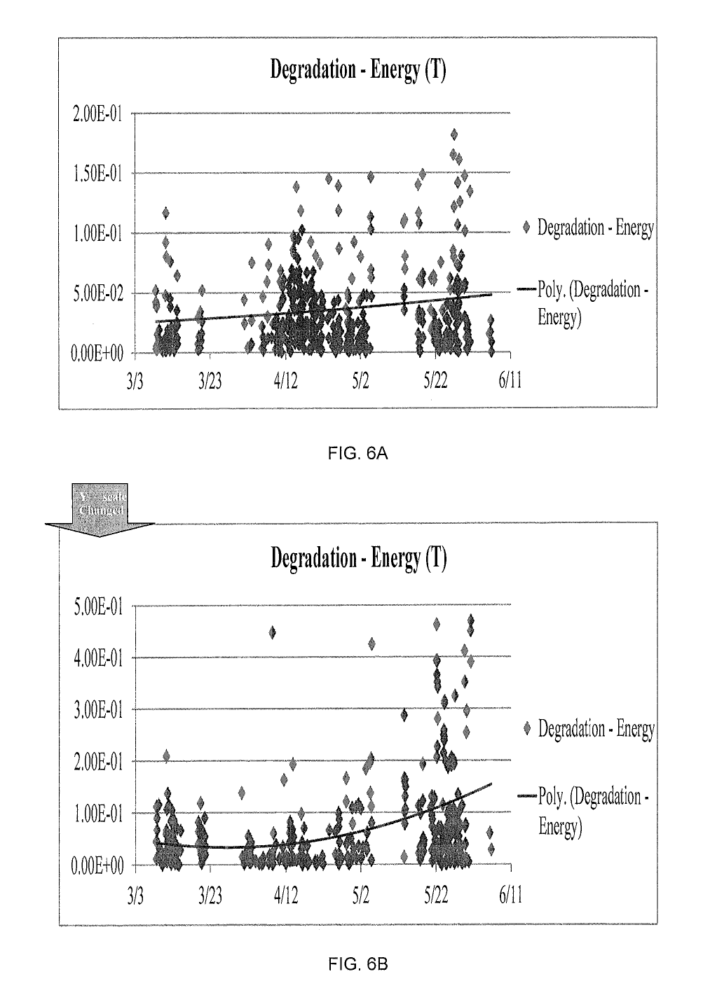

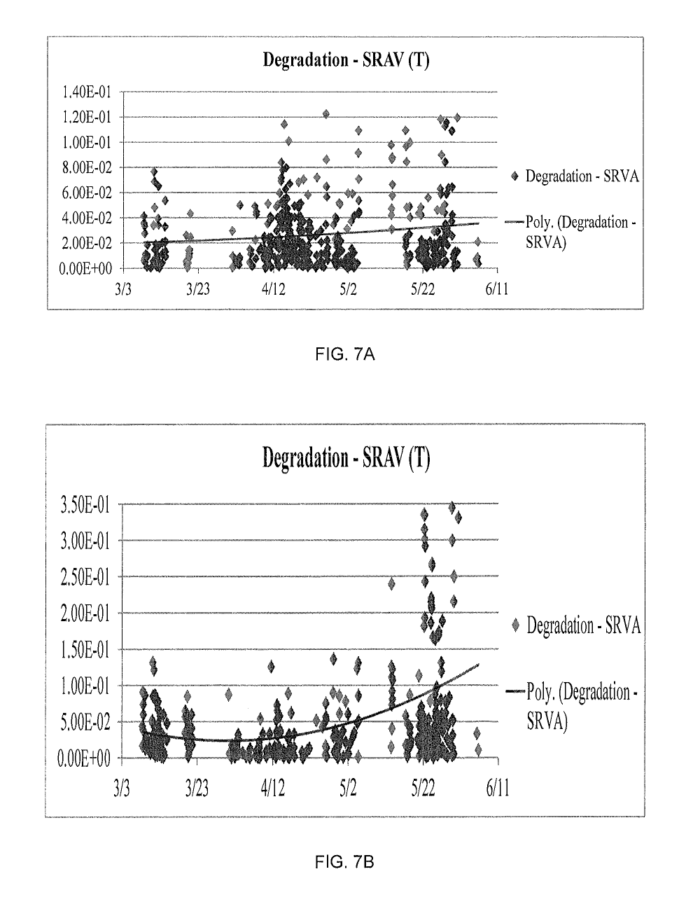

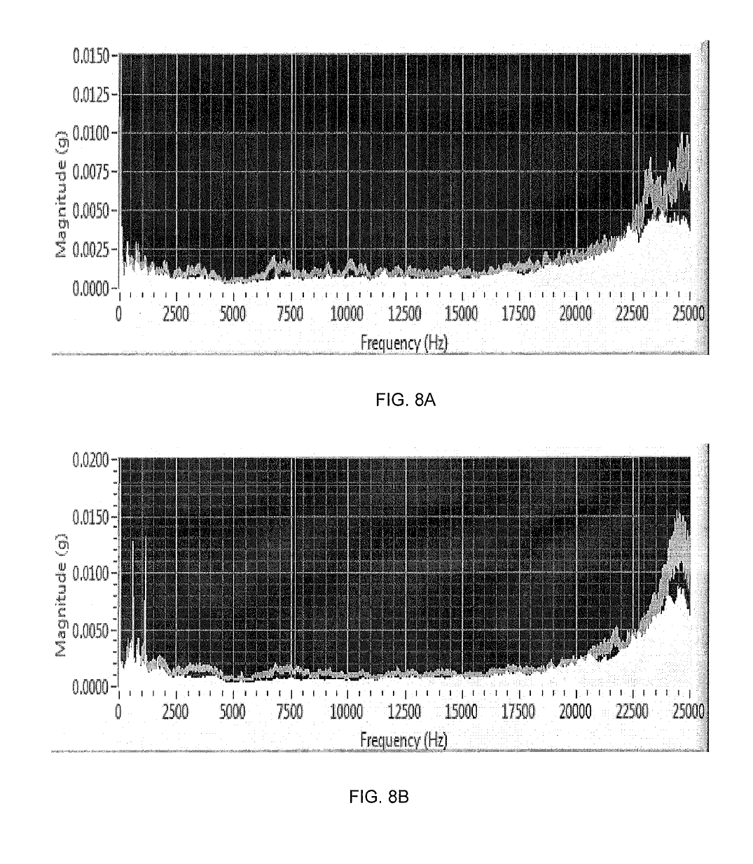

To enhance the significance of the fluctuation, a degradation operation was performed by subtracting the mean value from all the data points (FIG. 3B). The majority of data points which were close to the mean value were suppressed and the upward motion of trends caused by the fluctuating data points was enhanced. Even a slight movement of the original trends can be seen clearly after applying the degradation operation. The y-axes of the plots were adjusted based on the position of the majority of data points (FIGS. 4A-B, 5A-B, 6A-B, 7A-B). 98% of data points from the bottom were preserved, while the 2% of outliers from the top were eliminated.

The upward trends from the indicators show that the rate of deterioration captured from the 02 pump was larger than that of the G1 pump. The operating hours of the G1 pump were 3170 hours and those of the G2 pump were 4762 hours (data not shown). Although the benchmark hours of the G1 pump (3500 hrs) were longer than that of the G2 pump (2500 hrs), the G2 casing was 1592 hours older than the G1 casing. Without being bound by any theory, the higher upward trends for the G2 pump may have been caused by having an older casing.

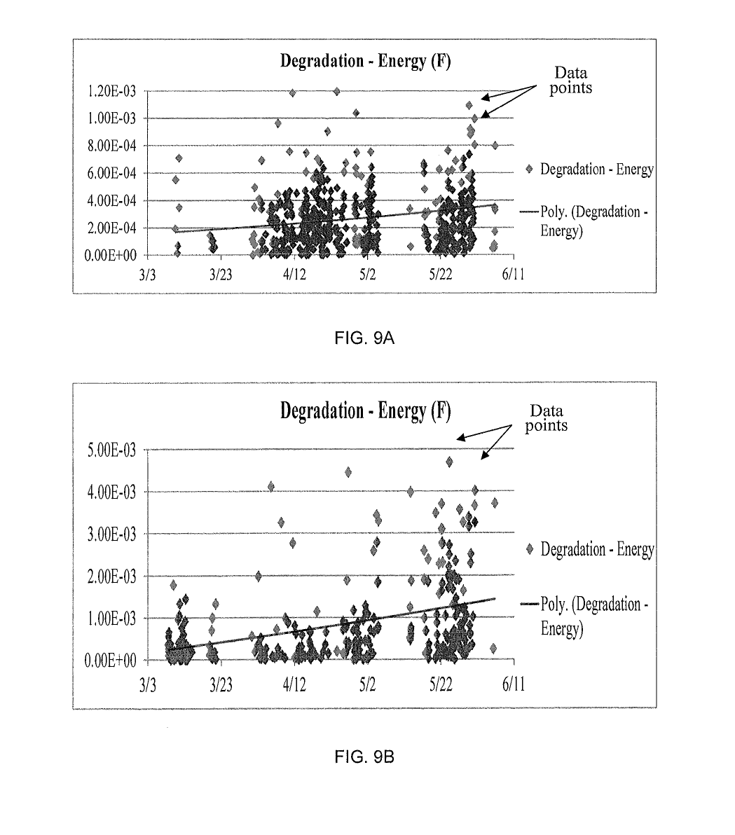

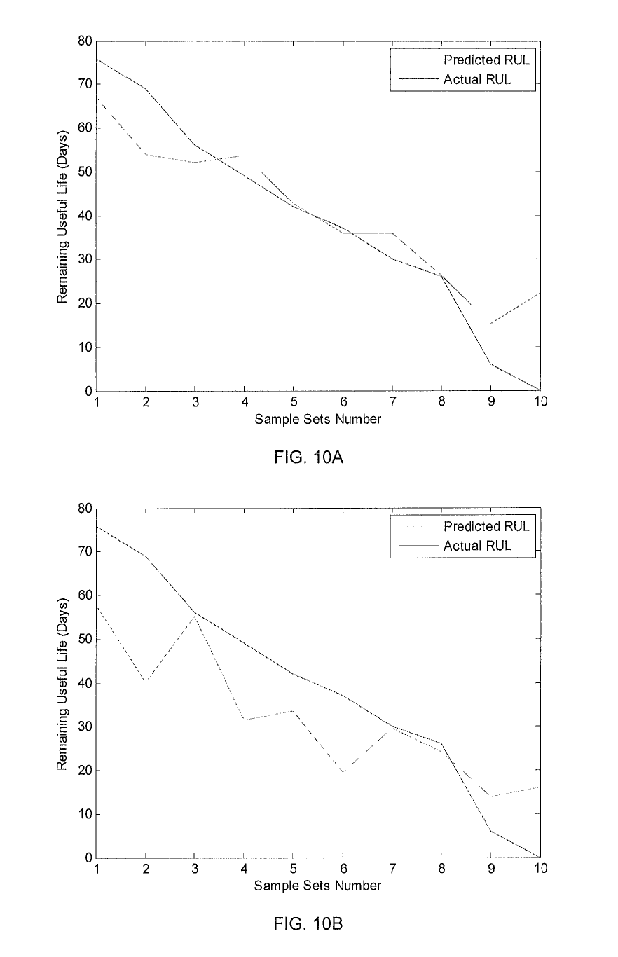

Frequency signals may be used to diagnose the condition of the impeller. Frequency signals (top area) were obtained by averaging two days in March with the impellers operating in normal condition, while the frequency signals (bottom area) were obtained by averaging two days in May with the running hours of the impellers approaching benchmark hours (FIGS. 8A-B). As the impeller wore out, its measured frequencies increased and the magnitudes of the top signals were higher than those of the bottom signals, especially in the high frequency region beyond 20 kHz. By observing the high frequency region, the higher magnitude signals contained more energy which was generated by the worn impellers. Through the monitoring of the magnitude changes and the calculated energy levels, impellers' running conditions can be obtained. About half of the high frequency components cannot be captured due to insufficient sampling rate. At least 60 kHz sampling rate should be applied to acquire the vibration signals up to 30 kHz in frequency signals. The indicators calculated from the high frequency signals in each measurement signals were analyzed and two are shown in FIGS. 9A-B. These indicators were processed using degradation and y-scale adjustment. Similar observations to the ones calculated from time signals were found. The data points concentrated on a lower level at the beginning of the measurement period and more fluctuations of the data points were found near the time of the next replacement of impellers. By calculating the fault trends using the data points, upward trends are observed. High frequency indicators are thus useful in showing the condition of impellers.

The collected vibration data were used to predict the RUL of the pumps using the following estimation methods:

i) Binary Support Vector Machine (SVM) classifiers

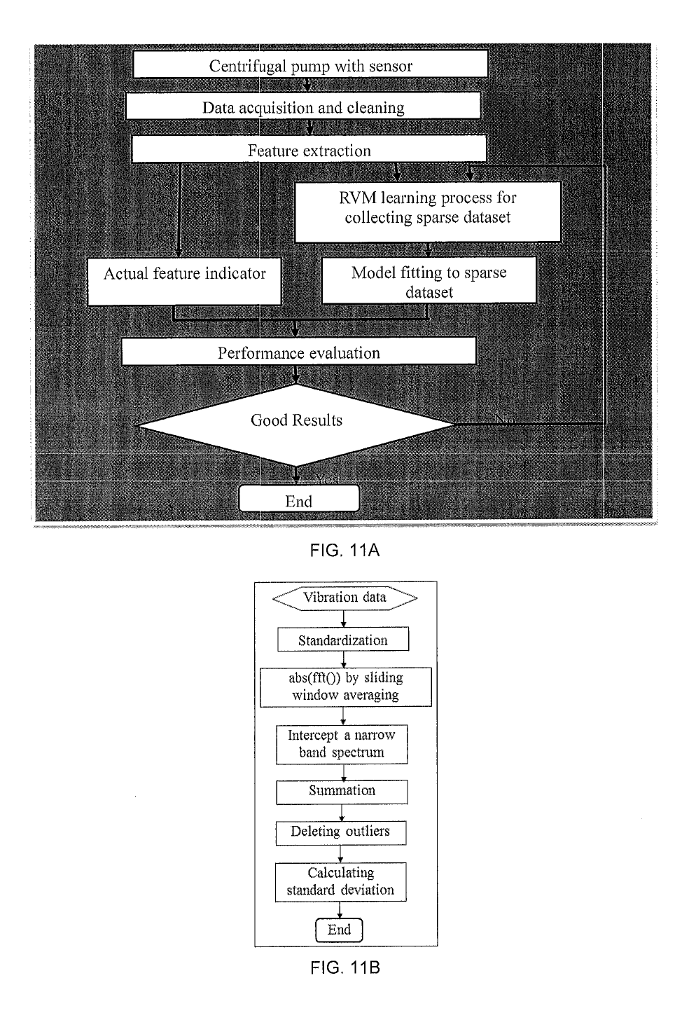

Eight statistical indicators (kurtosis, crest factor, clearance factor, shape factor, impulse indicator, variance, square root amplitude value, and absolute mean amplitude value) were extracted or calculated from the raw vibration data. Data sets collected in ten days were selected to train the SVM classifiers. The data captured by sensor C1 from the T2G1 pump are used for demonstration. The results of the predicted RUL (dashed line) are compared to the actual RUL (solid line) (FIG. 10A). A frequency range filter was added to the same set of data to select sub-band spectra energy within 0-400 Hz. The indicators were again extracted from this frequency range to train the SVM classifiers (FIG. 10B). The results on the predicted RULs are set out in Table 1.

TABLE 1

| Dates | RUL (days) |
|---|---|
| 1 | 76 |
| 2 | 69 |
| 3 | 56 |
| 4 | 49 |
| 5 | 42 |
| 6 | 37 |
| 7 | 30 |
| 8 | 26 |
| 9 | 6 |
| 10 | 0 |

### ii) Relevance Vector Machines (RVM) and Exponential Regression

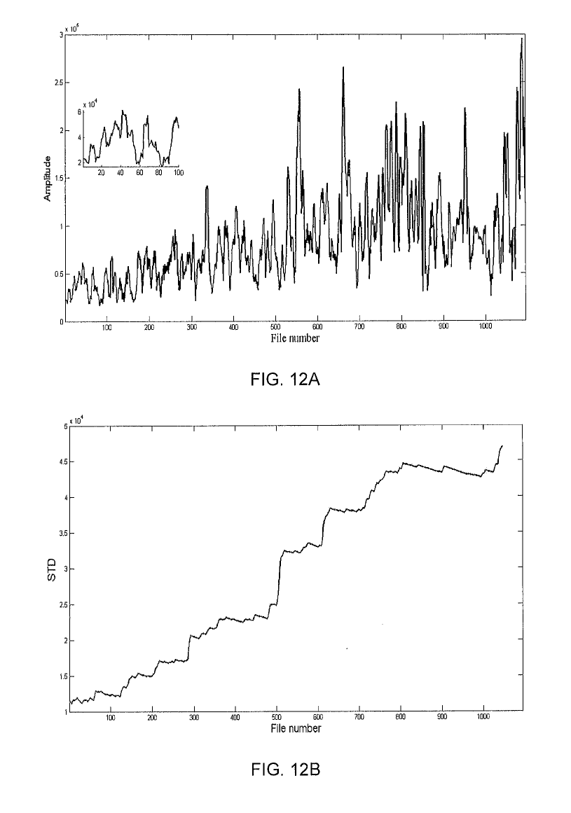

FIG. 11A is a flow chart of the RVM-based method. Statistical indicators were extracted from the raw vibration data (FIG. 11B). The narrow band was chosen as 33-60 Hz as the vane passing frequency component is located around 46 Hz. Energy evolution was calculated as:

$$\begin{matrix} \begin{matrix}\begin{matrix}\text{?} ( t , i ) = \frac{X ( t , i ) - mean ( X ( t , i ) )}{std ( X ( t , i ) )} , \\ \begin{matrix}Y ( t ) = \frac{1}{L} \text{?} abs ( fft ( \text{?} ( t , i ) ) ) \\ = {\int }_{f}^{ } y ( f , t ) d f ,\end{matrix}\end{matrix} \\ V ( t ) = {\int }_{33}^{60} y ( f , t ) d f ,\end{matrix} & ( 5 ) \\ \text{?} \text{indicates text missing or illegible when filed} & \end{matrix}$$

The standard deviation of energy evolution was calculated as:

STD(j)=std(V(1), V(2), . . . , V(j+q)). (6)

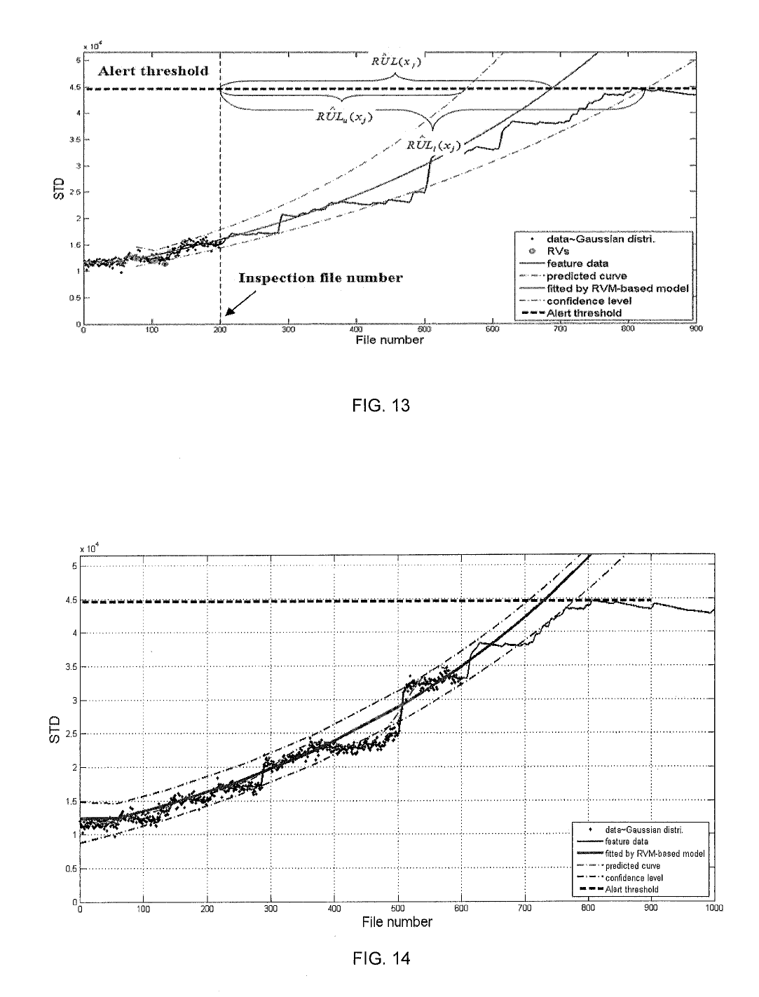

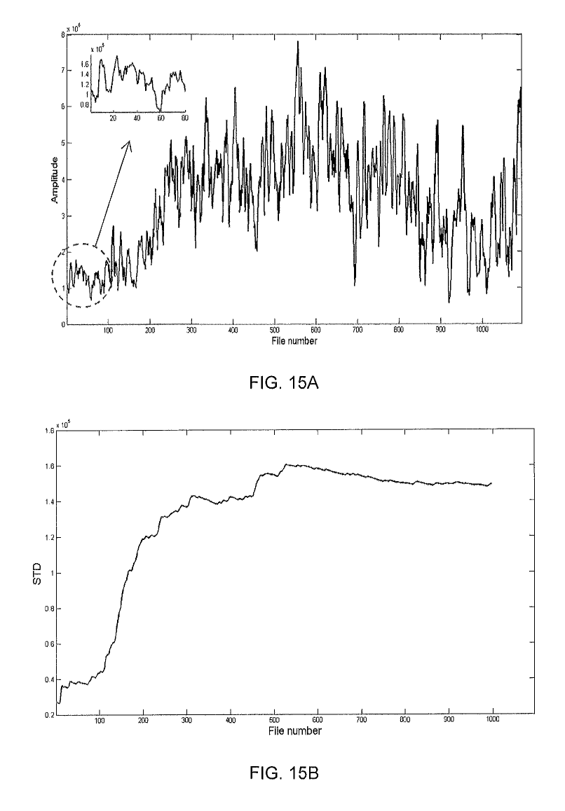

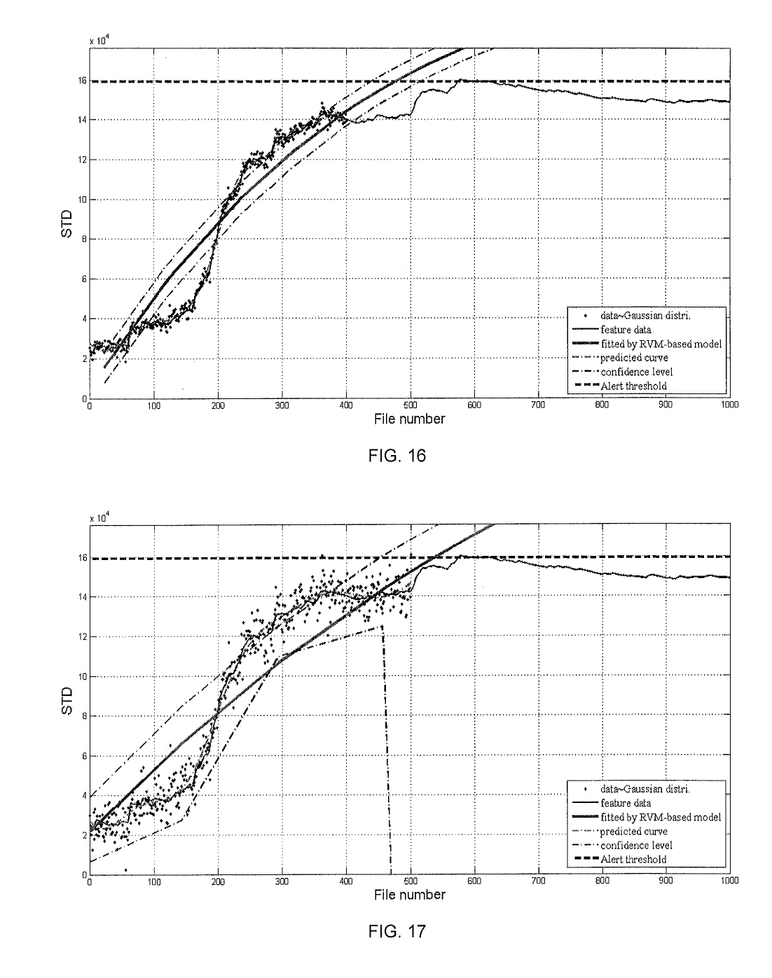

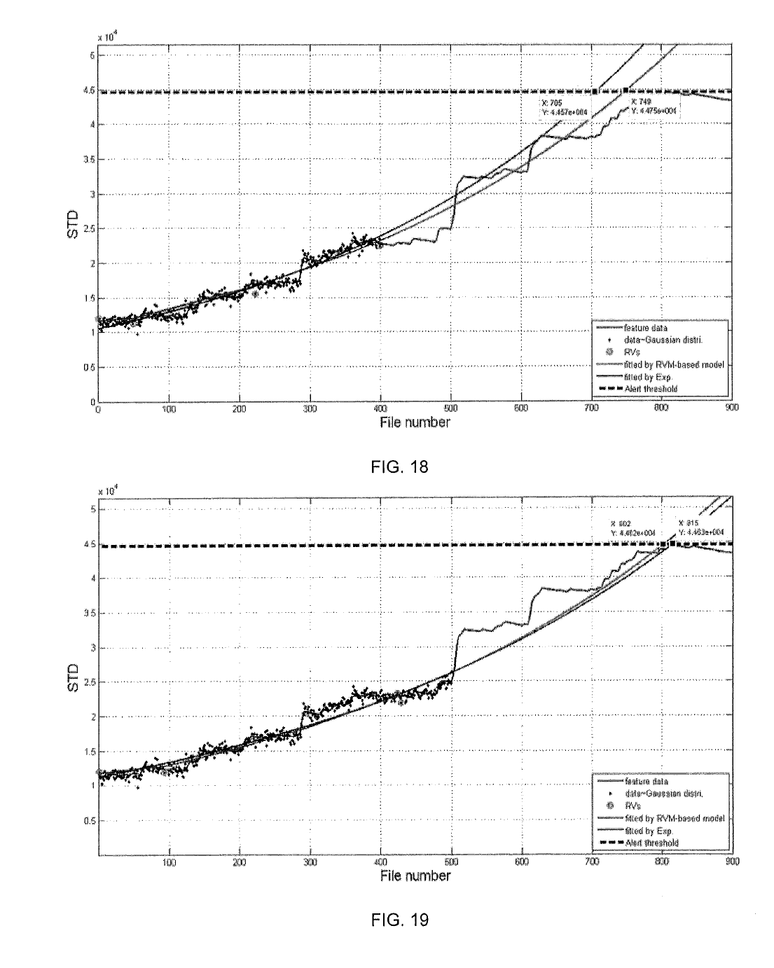

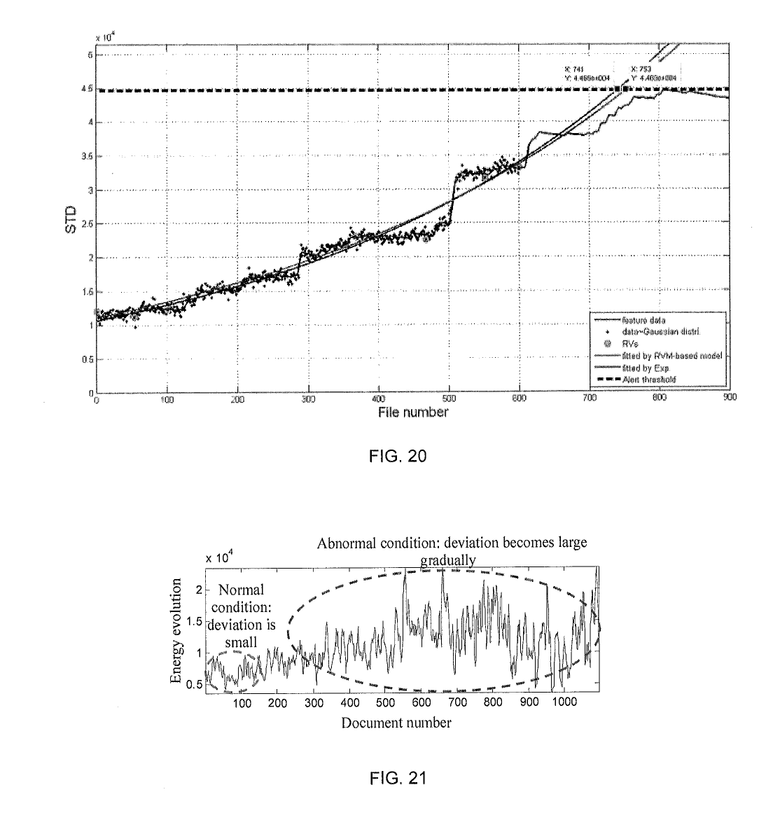

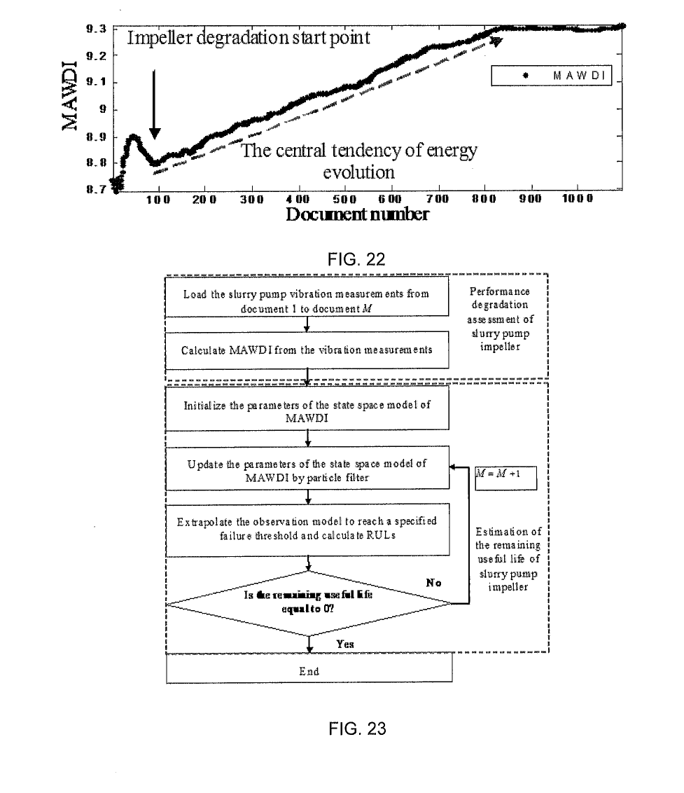

The evolution of energy degradation (FIG. 12A) and its standard deviation (FIG. 12B) as obtained from channel C3 of T2G1 data were determined. RUL is preferably predicted within a certain confidence and acceptable tolerance. FIG. 13 shows the estimated RUL of the impeller at inspection time Xj and the corresponding confidence bounds. FIG. 14 shows the estimated RUL of the impeller at inspection file number Xj=600 and the corresponding confidence bounds (T2G1-C3). Similar analyses were applied to vibration data obtained from channel C4 of the T2G1 pump (FIGS. 15A-B, 16, 17).

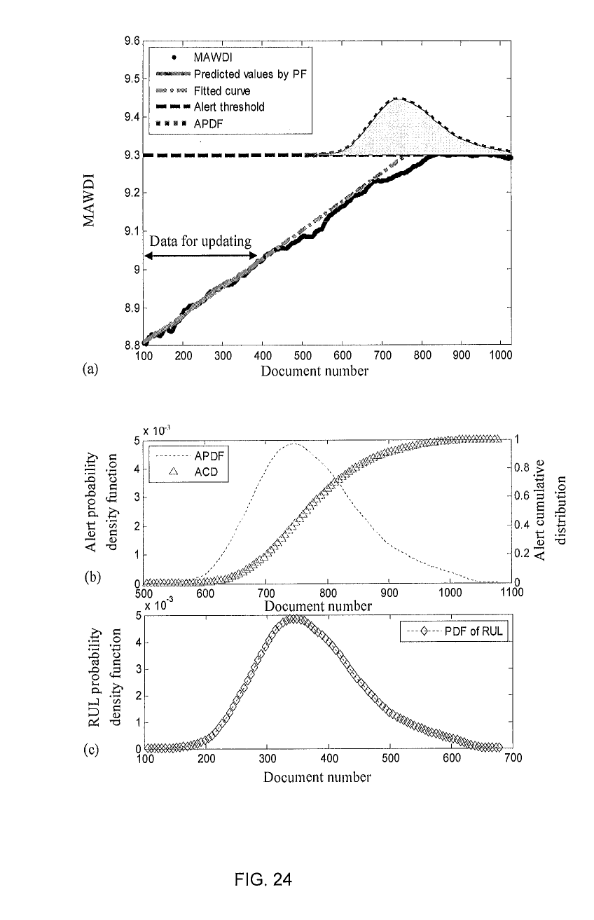

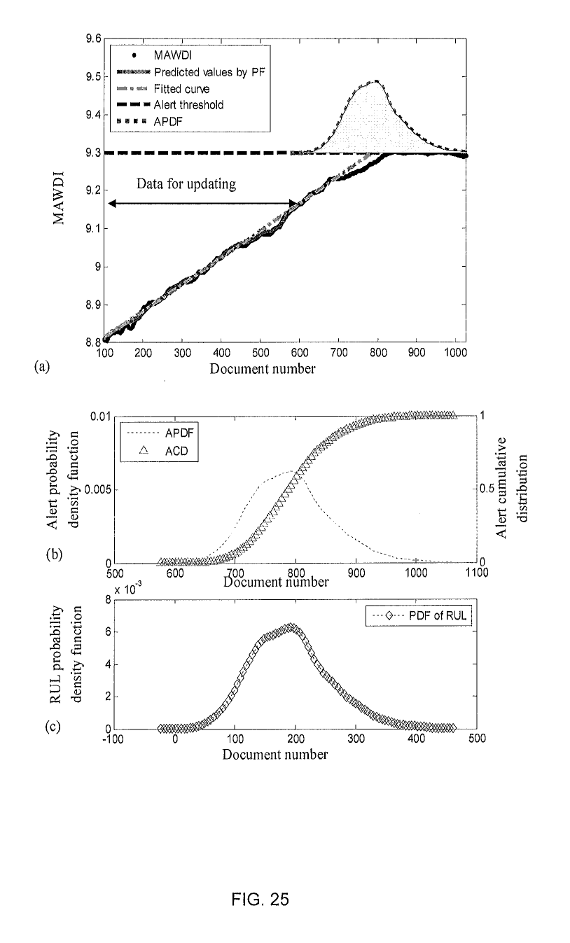

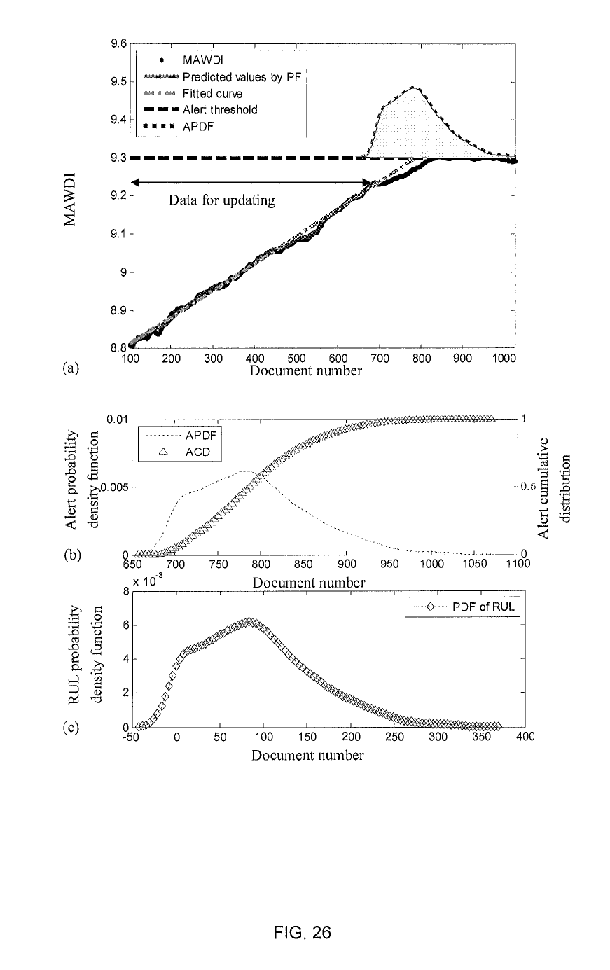

Further, comparisons were made of results obtained from the RVM+the sum of exponential regression, and only the sum of exponential regression (FIGS. 18-20). Table 2 compares the values of RUL predicted by RVM-based model and RVM+exponential fitting.

TABLE 2

| Inspection file | | By RVM-based | By RVM + |
|---|---|---|---|
| number | Actual | model | exponential fitting |
| 200 | 606 | 489 | 631 |
| 300 | 506 | 491 | 452 |
| 400 | 406 | 349 | 305 |
| 500 | 306 | 302 | 315 |
| 600 | 206 | 153 | 141 |
| 700 | 106 | 75 | 45 |

The results indicate that this method is easy to be derived and programmed. The sum of exponential functions is more flexible to fit many curves. A RUL trend with reasonable boundaries can be predicted.

iii) Moving-Average Wear Degradation Index (MAWDI) and Sequential Monte Carlo (SMC) Method

The energy evolution (EE) was defined as the amplitude summation of the frequency band covering the vane-passing frequency, with the cut-off frequencies being 40 Hz and 60 Hz:

$${y}_{k} ( t ) = ( {y}_{k } ( t ) - \frac{{\sum }_{t = 1}^{L} {y}_{k} ( t )}{L} ) / \sqrt{\frac{{\sum }_{t = 1}^{L} {( {y}_{k} ( t ) - \frac{{\sum }_{t = 1}^{L} {y}_{k} ( t )}{L} )}^{2}}{L - 1} \\} , \\ k = 1 , 2 , … , N \\ {y}_{k} ( f ) = {\sum }_{t = 1}^{L} {y}_{k} ( t ) {e}^{- 2 π i \times ( t - 1 ) \times ( f - 1 ) / L} , \\ k = 1 , 2 , … , N \\ EE ( k ) = {\sum }_{f = {f}_{1}}^{{f}_{2}} {y}_{k} ( f ) , \\ k = 1 , 2 , … , N \qquad ( 7 )$$

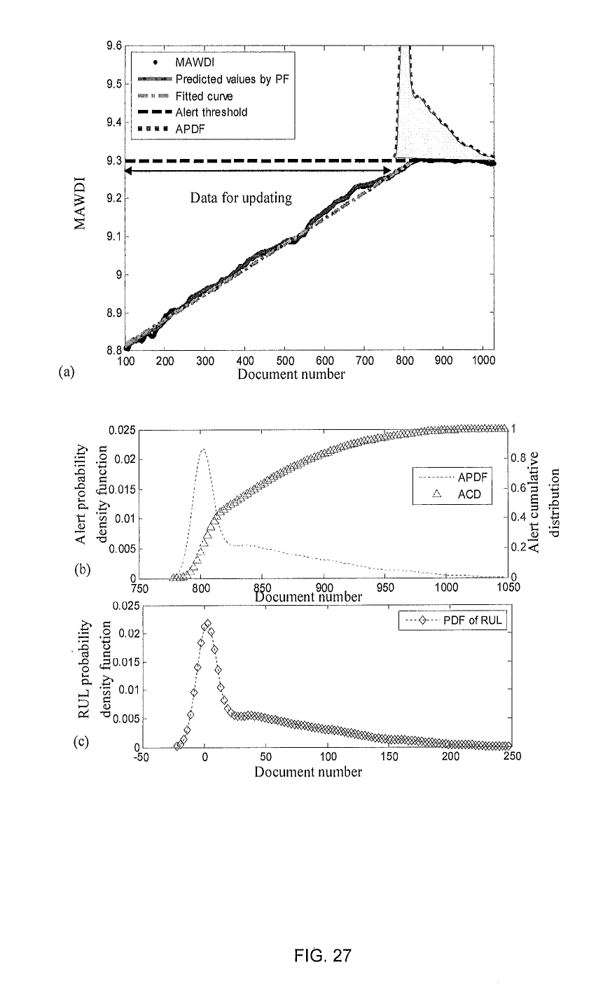

FIG. 21 shows the energy evolution of the frequency band covering the vane-passing frequency. Using the energy evolution, the MAWDI was calculated as:

$$MAWDI ( k ) = log ( \frac{{\sum }_{k - K + 1}^{k} EE ( k )}{K} ) , \\ k = 1 , 2 , … , N \qquad ( 8 )$$

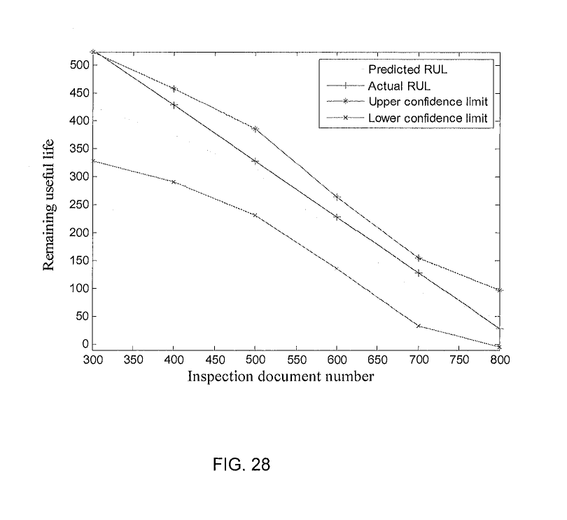

The MAWDI was used to track the current health status of the impeller using a health indicator, and to evaluate the deviation from a normal health condition. FIG. 22 shows a health assessment of an impeller using MAWDI.

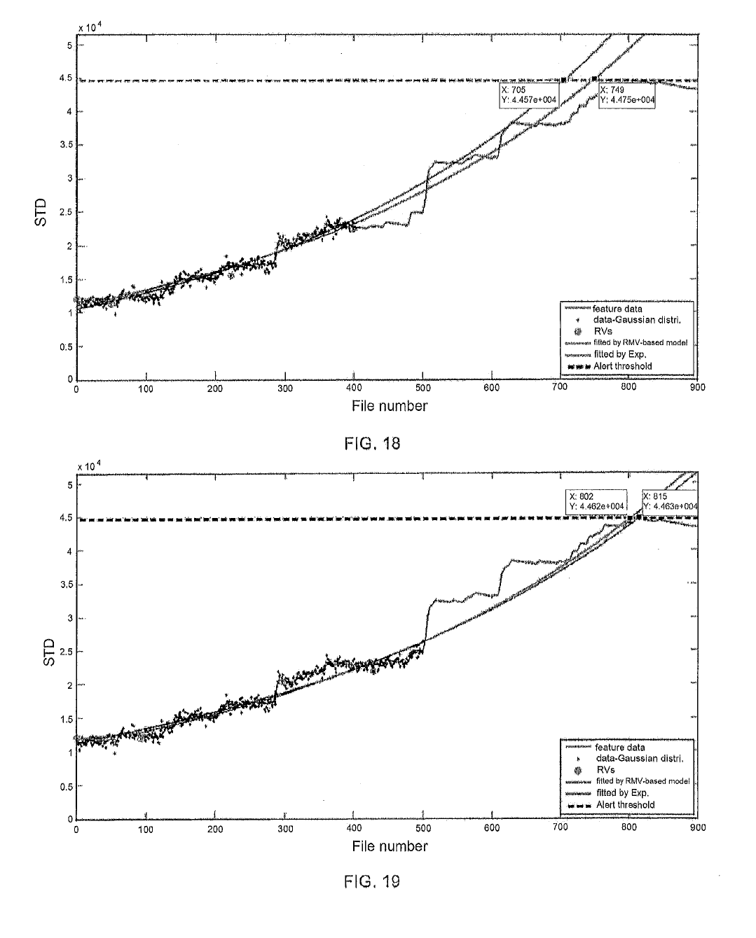

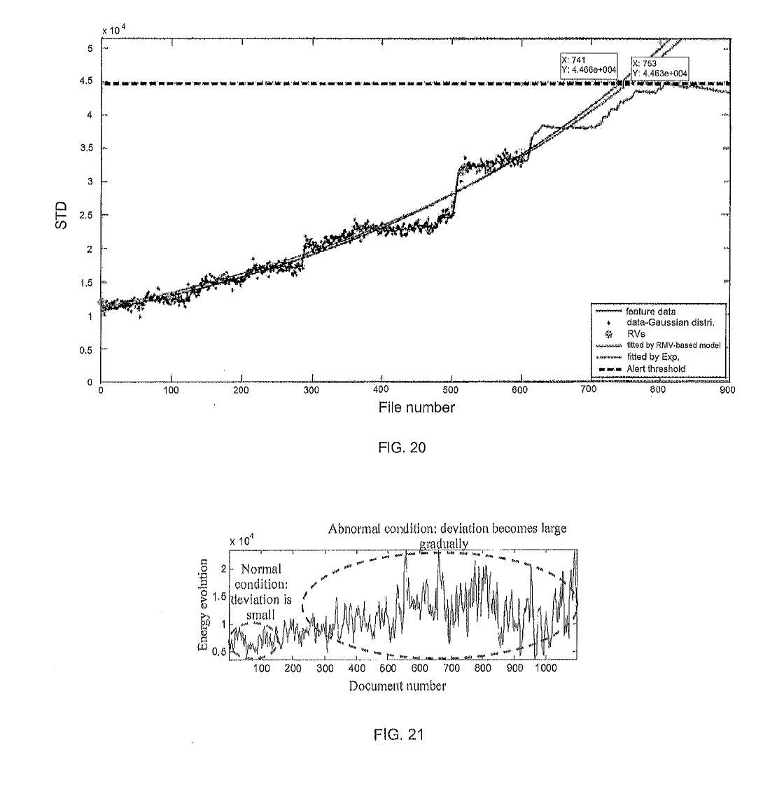

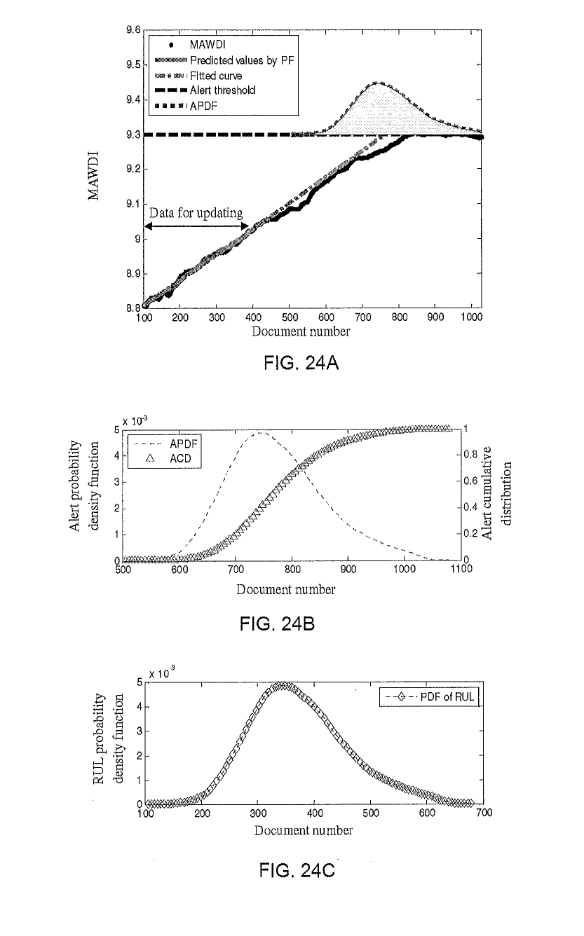

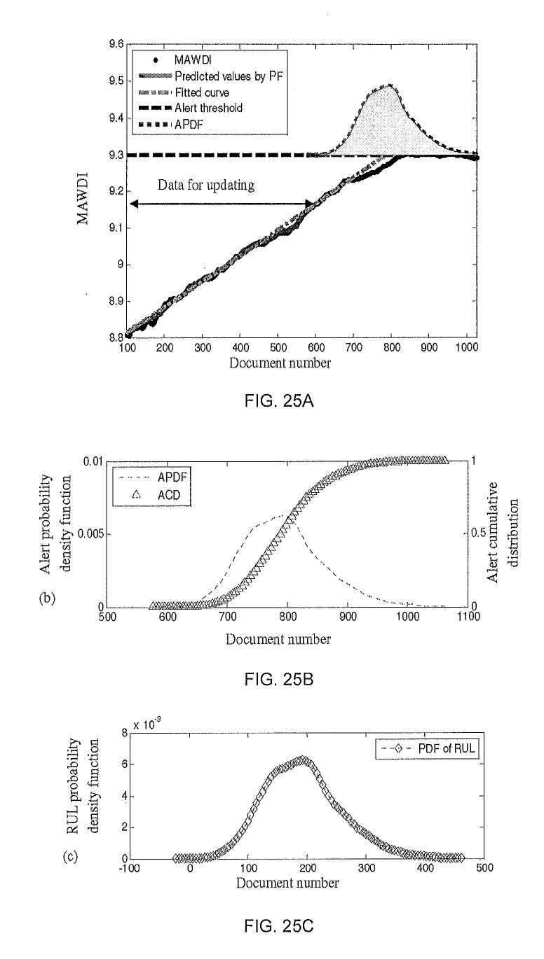

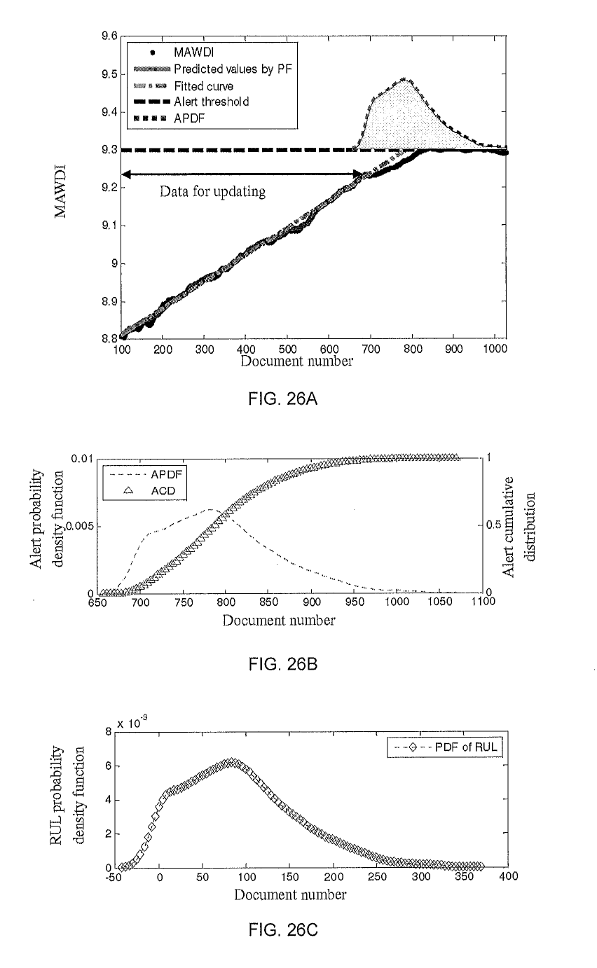

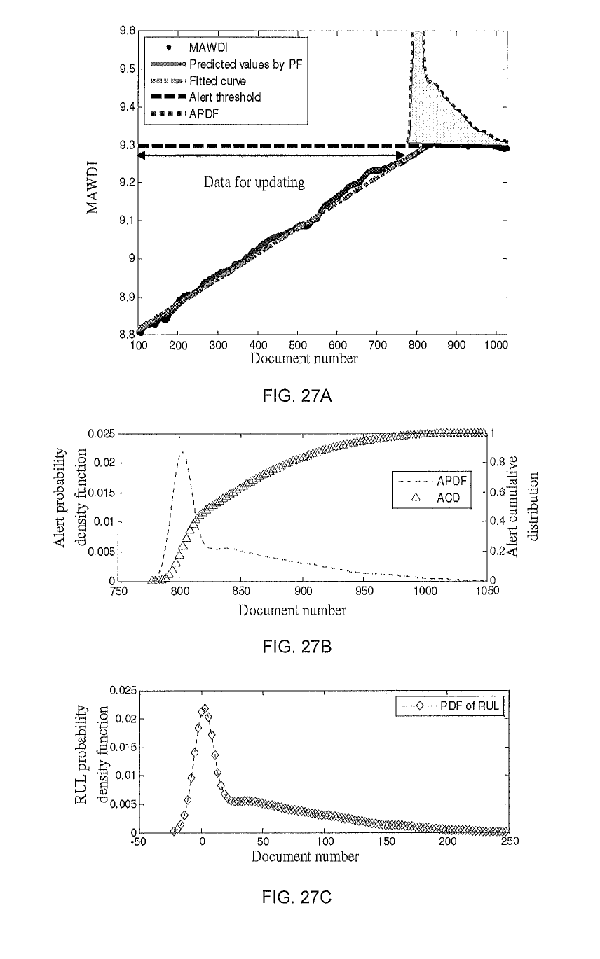

FIG. 23 shows the steps for estimating RUL. These steps were applied to vibration data obtained from the T2G1-C3 pump to generate predictive results of the RUL of the impeller (FIGS. 24A-C, 25A-C, 26A-C, and 27A-C). FIG. 28 shows predicted RUL, its uncertainties, and true RUL (predicted alert document numbers and their confidence limits for slurry pump impeller (T2G1-C3)).

Among the above estimation methods, SVM is less complicated and can provide the prediction of RUL values automatically but cannot define the uncertainty boundaries. The RVM method plus exponential regression, and the SMC method focus on the use of selected frequency range that has an increasing trend on fault features obtained from the selected frequency range. While the RVM method provides possible uncertainty boundaries, the SMC method provides a probability density function on calculating the RUL values and their uncertainties.

From the foregoing description, one skilled in the art can easily ascertain the essential characteristics of this invention. However, the scope of the claims should not be limited by the preferred embodiments set forth in the examples, but should be given the broadest interpretation consistent with the description as a whole.

What is claimed:

1. A method of diagnosing the condition of an impeller of a slurry pump comprising:
collecting vibration data from at least one accelerometer mounted to or proximate the pump over a specific time period;
calculating one or more indicators from the collected vibration data, the indicators including energy level, crest factor, square root amplitude value, and fault growth parameter; and
plotting the calculated indicators against time to generate a fault trend indicative of health or deterioration of the impeller.

2. The method of claim 1, further comprising converting the collected vibration data into frequency signals, and calculating the indicators from the frequency signals.

3. The method of claim 1, wherein the accelerometer is capable of detecting vibrations emitted from the pump during operation, and outputting and transmitting corresponding vibration response signals to a data logger operatively connected to the accelerometer.

4. The method of claim 3, comprising obtaining the vibration response signals from the data logger and transmitting the vibration response signals to a host computer, the computer being programmed to process and analyze the vibration response signals.

5. The method of claim 3, wherein the accelerometer detects vibrations ranging in frequency between about 5 Hz to about 60 kHz.

6. The method of claim 1, wherein the specific time period extends from an initial baseline time point to a subsequent time point.

7. The method of claim 6, wherein vibration data are collected per hour daily during the specific time period.

8. The method of claim 1, comprising dividing the vibration data into multiple percentages to calculate crest factor (20%).

9. The method of claim 1, wherein the fault trend comprises a polynomial trend or a linear trend.

10. The method of claim 9, further comprising subtracting a mean value of each indicator from each data point and plotting residual values.

11. The method of claim 10, further comprising adjusting the Y-scale to eliminate outliers.

12. The method of claim 1, further comprising activating an alert upon determination that the vibration data are indicative of deterioration of the impeller.

13. The method of claim 1, further comprising applying one or more prediction methods to the collected vibration data to predict the remaining useful life of the pump.

14. The method of claim 13, wherein the prediction methods are selected from support vector machine (SVM) classifiers, relevance vector machines (RVM) and exponential regression, a moving-average wear degradation index (MAWDI), or a sequential Monte Carlo (SMC) method.

15. The method of claim 14, wherein the prediction method comprises SVM classifiers.

16. The method of claim 15, comprising calculating kurtosis, clearance factor, shape factor, impulse indicator, variance, and absolute mean amplitude value from the collected vibration data.

17. The method of claim 16, comprising training the SVM classifiers with the calculated indicators.

18. The method of claim 17, comprising applying a frequency range filter to select vibration data having sub-band energies ranging between about 0 Hz to about 400 Hz.

19. The method of claim 18, comprising training the SVM classifiers with the filtered vibration data, wherein the SVM classifier predicts fault severity.

20. The method of claim 14, wherein the prediction method comprises RVM and exponential regression.

21. The method of claim 20, comprising selecting a frequency band covering frequencies ranging from about 33 Hz to about 60 Hz.

22. The method of claim 21, comprising calculating energy evolution and standard deviation from the collected vibration data.

23. The method of claim 22, comprising providing the calculated energy evolution and standard deviation to the RVM to obtain a fault trend.

24. The method of claim 14, wherein the prediction method comprises MAWDI and the SMC method.

25. The method of claim 24, comprising selecting a frequency band covering frequencies ranging from about 40 Hz to about 60 Hz.

26. The method of claim 25, comprising calculating energy evolution from the collected vibration data, and subsequently calculating the MAWDI.

27. The method of claim 26, comprising providing the MAWDI to the SMC method to obtain an estimation of the remaining useful life of the impeller.

28. The method of claim 1, further comprising outputting the plot to a display device.
